(19) United States
(12) Patent Application Publication
(10) Pub. No.: US 2019/0018335 A1
(43) Pub. Date: Jan. 17, 2019

(54) ELECTROPHOTOGRAPHIC INK INCLUDING A CHARGE DIRECTOR

(71) Applicant: Hp Indigo B.V., Amstelveen (NL)

(72) Inventors: Tal Rosenthal, Nes Ziona (IL); Marc KLEIN, Nes Ziona (IL); Eyal BACHAR, Nes Ziona (IL); Albert TEISHEV, Nes Ziona (IL); Shiran ZABAR, Nes Ziona (IL)

(73) Assignee: Hp Indigo B.V., Amstelveen (NL)

(21) Appl. No.: 16/070,424

(22) PCT Filed: Apr. 6, 2016
(86) PCT No.: PCT/EP2016/057507

§ 371 Date: Jul. 16, 2018

(51) Int. Cl. G03G 9/135; G03G 9/12; G03G 9/13

(52) U.S. Cl. CPC G03G 9/1355; G03G 9/131; G03G 9/122

(57) ABSTRACT

According to an example, a resin, a charge director, and a pigment may be ground to form a liquid electrophotographic ink.

### BACKGROUND

Ink compositions containing charged particles are used in a wide variety of applications such as toners in electrophotography printing, pigmented ink, electrophoretic displays as well as many other applications. Liquid electrophotographic printing is a specific type of electrophotographic printing where a liquid ink is employed in the process rather than a powder toner.

### BRIEF DESCRIPTION OF THE DRAWINGS

FIG. 1 is a line graph of particle size versus grinding time for various inks.

FIG. 2 is a line graph of tail 20% versus grinding time for various inks.

FIG. 3 is a line graph of optical density versus grinding time for various inks.

### DETAILED DESCRIPTION

For simplicity and illustrative purposes, the present disclosure is described by referring mainly to examples thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on” means based at least in part on.

Resins may have varying degrees of hardness. Generally, the harder the resin, then the longer it may take to grind the resin during a formulation process in order to obtain a desired particle size. The increased time to grind the resin may translate into an increase in energy used during production and an increase in the resultant cost of goods. Unfortunately, simply decreasing the grinding time of a harder resin may still result in a decreased optical density for the ink.

The liquid electrophotographic ink disclosed herein may be formed by grinding a resin, a pigment, and a charge director, such as a synthetic charge director. It will be noted that the method disclosed herein may vary from prior methods because the resin, pigment, and synthetic charge director are subjected to grinding at an initial stage in the production process. Through implementation of the disclosed method, in which the charge director is ground with the resin, the resultant liquid electrophotographic ink may exhibit a decreased process time, a decreased particle size, and/or an increased optical density as compared with inks in which a charge director is not ground with the resin during an initial stage in the production process.

The resin used in the liquid electrophotographic ink composition may include a polymer. The resin may include, but is not limited to, a thermoplastic polymer. As used herein, “ethylene acrylic acid copolymer resin” generally refers to both ethylene acrylic acid copolymer resins and ethylene methacrylic acid copolymer resins, unless the context dictates otherwise. As used herein, “high acid” refers to a resin or copolymer having an acid content of at least about 15 wt. % measured as the percent of the polymer that is the acid monomer by weight. As used herein, “high melt viscosity” refers to a resin or copolymer having a melt viscosity of at least about 20,000 poise measured by an AR-2000 Rheometer by Thermal Analysis Instruments with geometry of 25 mm steel plate-standard steel parallel plate. The device can use a plate over plate rheometry isotherm at 120° C., 0.01 Hz shear rate.

The resin may be an ethylene acrylic acid copolymer resin. The resin may have a high acid content. The resin may have a high melt viscosity. The polymer of the resin may be selected from ethylene acrylic acid copolymers; methacrylic acid copolymers; ethylene vinyl acetate copolymers; copolymers of ethylene (e.g. from about 80 wt. % to about 99.9 wt. %), and alkyl (e.g. C₁ to C₅) ester of methacrylic or acrylic acid (e.g. from about 0.1 wt. % to about 20 wt. %); copolymers of ethylene (e.g. from about 80 wt. % to about 99.9 wt. %), acrylic or methacrylic acid (e.g. from about 0.1 wt. % to about 20.0 wt. %) and alkyl (e.g. C₁ to C₅) ester of methacrylic or acrylic acid (e.g. from about 0.1 wt. % to about 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is in some examples from about 1 to about 20 carbon atoms, such as methyl methacrylate (e.g. from about 50 wt. % to about 90 wt. %)/methacrylic acid (e.g. from about 0 wt. % to about 20 wt. %)/ethylhexylacrylate (e.g. from about 10 wt. % to about 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

The resin may comprise a polymer having acidic side groups. The polymer having acidic side groups may have an acidity of about 10 mg KOH/g or more, in some examples an acidity of about 20 mg KOH/g or more, in some examples an acidity of about 30 mg KOH/g or more, in some examples an acidity of about 40 mg KOH/g or more, in some examples an acidity of about 50 mg KOH/g or more, in some examples an acidity of about 60 mg KOH/g or more, in some examples an acidity of about 70 mg KOH/g or more, in some examples an acidity of about 80 mg KOH/g or more, in some examples an acidity of about 90 mg KOH/g or more, in some examples an acidity of about 100 mg KOH/g or more, in some examples an acidity of about 105 mg KOH/g or more, in some examples about 110 mg KOH/g or more, in some examples about 115 mg KOH/g or more. The polymer having acidic side groups may have an acidity of about 200 mg KOH/g or less, in some examples about 190 mg KOH/g or less, in some examples about 180 mg KOH/g or less, in some examples about 130 mg KOH/g or less, in some examples about 120 mg KOH/g or less. Acidity of a polymer, as measured in mg KOH/g can be measured using standard procedures known in the art, for example using the procedure described in ASTM D1386.

The high acid ethylene acrylic acid copolymer resin may have an acid content of at least about 15 wt. % and a viscosity of at least about 8,000 poise. Generally, the liquid electrophotographic ink may have a total resin acidity of at least about 15 wt. % and a total resin melt viscosity of at least about 20,000 poise. However, in one example, the ink may exclude resins/copolymers having a viscosity of less than about 8,000 poise. Additionally, in another example, the ink may exclude resins/copolymers having an acidity of less than about 15 wt. %. In some more specific examples, the high acid ethylene acrylic acid copolymer resins may have an acid content of at least about 18 wt. %. In another example, the high acid ethylene acrylic acid copolymer resin may have an acid content of at least about 20 wt. %. In still another example, the high melt viscosity ethylene acrylic acid copolymer resin may have a melt viscosity of at least about 100,000 poise, or for example, at least about 200,000 poise. The high melt viscosity ethylene acrylic acid copolymer resin and/or the high acid ethylene acrylic acid copolymer resin may also both have a molecule weight (M_{w}) of at least about 40,000.

Non-limiting examples of the resin include the Nucrel family of toners (e.g. Nucrel 403™, Nucrel 407™, Nucrel 609HS™, Nucrel 908HS™, Nucrel 1202HC™, Nucrel 30707™, Nucrel 1214™, Nucrel 903™, Nucrel 3990™, Nucrel 910™, Nucrel 925™, Nucrel 699™, Nucrel 599™, Nucrel 960™, Nucrel RX 76™, Nucrel 2806™, Bynell 2002, Bynell 2014, Bynell 2022, and Bynell 2020 (sold by E. I. du PONT)), the Aclyn family of toners (e.g. Aclyn 201, Aclyn 246, Aclyn 285, and Aclyn 295), and the Lotader family of toners (e.g. Lotader 2210, Lotader, 3430, and Lotader 8200 (sold by Arkema)) and AC5120 (an ethylene acrylic acid copolymer from Allied Signal).

The resin may constitute about 5% to about 90%, in some examples about 5% to about 80%, by weight of the solids of the liquid electrophotographic ink composition, for example from about 10% to about 75% by weight. Additionally, the resin may constitute about 10% to about 60% by weight of the solids of the liquid electrophotographic ink composition. Moreover, the resin may constitute about 15% to about 40% by weight of the solids of the liquid electrophotographic ink composition.

The resin may encapsulate a pigment during mixing to create an ink particle. The ink particle may have a final particle size ranging from about 1 micron to about 10 microns. The resin encapsulated pigments may be formulated to provide a specific melting point. In one example, the melting point may be from about 30° C. to about 150° C., and for example, from about 50° C. to about 100° C. Such melting points may allow for desired film formation during printing.

Generally, a carrier liquid may act as a dispersing medium for the other components in the liquid electrophotographic ink. The carrier liquid may have or be a hydrocarbon, silicone oil, vegetable oil, etc. The carrier liquid may include, but is not limited to, an insulating, non-polar, non-aqueous liquid that may be used as a medium for articles. In an aspect, the carrier liquid may be a low dielectric (<2 dielectric constant) solvent.

The carrier liquid may include, but is not limited to, hydrocarbons. The hydrocarbon may include, but is not limited to, an aliphatic hydrocarbon, an isomerized aliphatic hydrocarbon, branched chain aliphatic hydrocarbons, aromatic hydrocarbons, and combinations thereof. Non-limiting examples of a carrier liquid may include aliphatic hydrocarbons, isoparaffinic compounds, paraffinic compounds, dearomatized hydrocarbon compounds, and the like. In particular, the carrier liquid may be chosen from IsoparG™, Isopar-H™, Isopar-L™, Isopar-M™, Isopar-K™, Isopar-V™, Norpar 12™, Norpar 13™, Norpar 15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol 300™, Nisseki Isosol 400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™)

The carrier liquid may be present in the liquid electrophotographic ink composition in an amount ranging from about 20% to about 99.5% by weight of the electrophotographic ink composition, and in some examples about 50% to about 90% by weight of the electrophotographic ink composition. In another example, the carrier liquid may be present in an amount ranging from about 60% to about 80% by weight of the electrophotographic ink composition.

The liquid electrophotographic ink composition may include a pigment. Non-limiting examples of pigments include cyan pigments, magenta pigments, yellow pigments, white pigments, black pigments, phosphorescent pigments, electroluminescent pigments, photoluminescent pigments, pearlescent pigments, and combinations thereof. Non-limiting examples of pigments include pigments by Hoechst including Permanent Yellow DHG, Permanent Yellow GR, Permanent Yellow G, Permanent Yellow NCG-71, Permanent Yellow GG, Hansa Yellow RA, Hansa Brilliant Yellow 5GX-02, Hansa Yellow X, NOVAPERM® YELLOW HR, NOVAPERM® YELLOW FGL, Hansa Brilliant Yellow 10GX, Permanent Yellow G3R-01, HOSTAPERM® YELLOW H4G, HOSTAPERM® YELLOW H3G, HOSTAPERM® ORANGE GR, HOSTAPERM® SCARLET GO, Permanent Rubine F6B; pigments by Sun Chemical including L74-1357 Yellow, L75-1331 Yellow, L75-2337 Yellow; pigments by Heubach including DALAMAR® YELLOW YT-858-D; pigments by Ciba-Geigy including CROMOPHTHAL® YELLOW 3 G, CROMOPHTHAL® YELLOW GR, CROMOPHTHAL® YELLOW 8 G, IRGAZINE® YELLOW SGT, IRGALITE® RUBINE 4BL, MONASTRAL® MAGENTA, MONASTRAL® SCARLET, MONASTRAL® VIOLET, MONASTRAL® RED, MONASTRAL® VIOLET; pigments by BASF including LUMOGEN® LIGHT YELLOW, PALIOGEN® ORANGE, HELIOGEN® BLUE L 690 IF, HELIOGEN® BLUE TBD 7010, HELIOGEN® BLUE K 7090, HELIOGEN® BLUE L 710 IF, HELIOGEN® BLUE L 6470, HELIOGEN® GREEN K 8683, HELIOGEN® GREEN L 9140; pigments by Mobay including QUINDO® MAGENTA, INDOFAST® BRILLIANT SCARLET, QUINDO® RED 6700, QUINDO® RED 6713, INDOFAST® VIOLET; pigments by Cabot including Maroon B STERLING® NS BLACK, STERLING® NSX 76, MOGUL® L; pigments by DuPont including TIPURE® R-101; and pigments by Paul Uhlich including UHLICH® BK 8200.

According to an example, the pigment may be a phosphorescent pigment having strontium oxide aluminate phosphor particles. The phosphorescent pigment may be chosen from LUMINOVA® BGL-300FF (blue-green emitting), LUMINOVA® GLL-300(I) FF (green emitting), and LUMINOVA® V-300M (violet emitting), GBU (yellowish green emitting), all of which are available from United Mineral and Chemical Corporation; UltraGreen V10(PDPG) (green emitting) available from Glow Inc.; and LUPL34/2 (turquoise emitting), LUPL24/2 (green emitting), LUPLO9 (orange emitting), all of which are available from Luminochem from Hungary, Budapest.

In one example, the resin coated pigment particles may have a median particle size (d₅₀) of less than about 40 μm, for example less than about 30 μm, less than about 20 μm, less than about 19 μm, less than about 16 μm, less than about 14 μm, less than about 12 μm, less than about 11 μm. In one example, the resin coated pigment particles may have a median particle size (d₅₀) of at least about 4 μm, for example at least about 5 μm, at least about 6 μm. In one example, the median particle size may range from about 2 μm to about 13 μm, for example from about 3 μm to about 12 μm, and as a further example from about 4 μm to about 11 μm.

In one example, the resin coated pigment particles may have a percentage of particles having a size greater than about 20 μm (“Tail 20”) of less than about 45%, for example less than about 40%, less than about 39%, less than about 38%, less than about 37%. In one example, the polymer resin coated pigment particles may have a percentage of particles having a size greater than about 20 μm (“Tail 20”) of at least about 25%, for example at least about 27%, at least about 28%, at least about 29%, at least about 30%.

A charge director imparts a charge to the liquid electrophotographic ink, which may be identical to the charge of a photoconductive surface. The electrophotographic ink composition may include a charge director, such as a synthetic charge director, having a sulfosuccinate salt of the general formula MAn, in which M is a metal, n is the valence of M, and A is an ion of the general formula (I):

[R¹—O—C(O)CH₂CH(SO₃⁻)C(O)—O—R²]⁻ (I)

in which each of R¹ and R² may be an alkyl group.

The charge director may be added in order to impart and/or maintain sufficient electrostatic charge on the ink particles.

The sulfosuccinate salt of the general formula MAn may be an example of a micelle forming salt. The charge director may be substantially free or free of an acid of the general formula HA, where A is as described above. The charge director may include micelles of the sulfosuccinate salt enclosing at least some of the nanoparticles. The charge director may include at least some nanoparticles having a size of 200 nm or less, and/or in some examples 2 nm or more.

The charge director may further have a simple salt. Simple salts are salts that do not form micelles by themselves, although they may form a core for micelles with a micelle forming salt. The ions constructing the simple salts are all hydrophilic. The simple salt may include a cation selected from the group consisting of Mg⁺², Ca⁺², Ba⁺², NH₄+, tert-butyl ammonium, Li⁺, and Al⁺³, or from any sub-group thereof. The simple salt may include an anion selected from the group consisting of SO₄²⁻, PO₄³⁻, NO³⁻, HPO₄²⁻, C0₃²⁻, acetate, trifluoroacetate (TFA), Br, Cl⁻, BF₄⁻, F—, ClO₄—, and TiO₃⁴⁻, or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, Tert-butyl ammonium bromide, NH₄NO₃, LiTFA, Al₂(SO₄)₃, LiClO₄ and LiBF₄, or any sub-group thereof. The charge director may further include basic barium petronate (BBP).

In the formula [R¹—O—C(O)CH₂CH(SO₃⁻)C(O)—O—R²], for example each of R¹ and R² may be independently an aliphatic alkyl group, such as a C₆₋₂₅ alkyl. The aliphatic alkyl group may be linear or branched. The aliphatic alkyl group may have a linear chain of more than 6 carbon atoms. R¹ and R² may be the same or different. In some examples, at least one of R¹ and R² is C₁₃H₂₇. In some examples, M is Na, K, Cs, Ca, or Ba.

The charge director may further include one of, some of or all of (i) soya lecithin, (ii) a barium sulfonate salt, such as basic barium petronate (BPP), and (iii) an isopropyl amine sulfonate salt. Basic barium petronate is a barium sulfonate salt of a 21-26 hydrocarbon alkyl, and may be obtained, for example, from Chemtura. An example isopropyl amine sulphonate salt is dodecyl benzene sulfonic acid isopropyl amine, which is available from Croda.

In some examples, the charge director may constitute about 0.001% to about 20%, for example, from about 0.01% to about 20% by weight, as an additional example from about 0.01 to about 10% by weight, and as a further example from about 0.01% to about 1% by weight of the solids of an electrophotographic ink composition. The charge director may constitute from about 0.001% to about 0.15% by weight of the solids of the electrophotographic ink composition, for example from about 0.001% to about 0.15%, as a further example from about 0.001% to about 0.02% by weight of the solids of an electrophotographic ink composition, for example from about 0.1% to about 2% by weight of the solids of the electrophotographic ink composition, for example from about 0.2% to about 1.5% by weight of the solids of the electrophotographic ink composition in an example from about 0.1% to about 1% by weight of the solids of the electrophotographic ink composition, for example from about 0.2% to about 0.8% by weight of the solids of the electrophotographic ink composition. The charge director may be present in an amount of at least about 1 mg of charge director per gram of solids of the electrophotographic ink composition (which will be abbreviated to mg/g), for example, at least about 2 mg/g, in a further example at least about 3 mg/g, in another example at least about 4 mg/g, for example, at least about 5 mg/g. The charge director may be present in an amount of from about 1 mg to about 50 mg of charge director per gram of solids of the electrostatic ink composition (which will be abbreviated to mg/g), for example from about 1 mg/g to about 25 mg/g, as a further example from about 1 mg/g to about 20 mg/g, for example from about 1 mg/g to about 15 mg/g, as an additional example from about 1 mg/g to about 10 mg/g, for example from about 3 mg/g to about 20 mg/g, as a further example from about 3 mg/g to about 15 mg/g, and for example from about 5 mg/g to about 10 mg/g. In another example, the charge director may be present in an amount ranging from about 1.5 mg/gr to about 4.0 mg/gr of solids of the ink, for example from about 1.75 mg/gr to about 2.5 mg/gr, and as a further example about 2.0 mg/gr.

The electrophotographic ink composition may include a charge adjuvant. A charge adjuvant may promote charging of the particles when a charge director is present. The method as described here may involve adding a charge adjuvant at any stage. The charge adjuvant may include, but is not limited to, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), and hydroxy bis(3,5-di-tert-butyl salicylic) aluminate monohydrate. In an example, the charge adjuvant may be or may include aluminum di- or tristearate.

The charge adjuvant may be present in an amount of from about 0.1 to about 5% by weight, for example from about 0.1 to about 1% by weight, in some examples from about 0.3 to about 0.8% by weight of the solids of the electrophotographic ink composition, in some examples from about 1 wt. % to about 3 wt. % of the solids of the electrophotographic ink composition, in some examples from about 1.5 wt. % to about 2.5 wt. % of the solids of the electrophotographic ink composition.

In some examples, the electrophotographic ink composition may include, e.g., as a charge adjuvant, a salt of multivalent cation and a fatty acid anion. The salt of multivalent cation and a fatty acid anion may act as a charge adjuvant. The multivalent cation may, in some examples, be a divalent or a trivalent cation. In some examples, the multivalent cation may be selected from Group 2, transition metals and Group 3 and Group 4 in the Periodic Table. In some examples, the multivalent cation may include a metal selected from Ca, Sc, Ti, V, Cr, Mn, Fe, Co, Ni, Cu, Zn, Al and Pb. In some examples, the multivalent cation is Al3+. The fatty acid anion may be selected from a saturated or unsaturated fatty acid anion. The fatty acid anion may be selected from a C₈ to C₂₆ fatty acid anion, in some examples a C₁₄ to C₂₂ fatty acid anion, in some examples a C₁₆ to C₂₀ fatty acid anion, in some examples a C₁₇, C₁₈ or C₁₉ fatty acid anion. In some examples, the fatty acid anion may be selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of multivalent cation and a fatty acid anion, may be present in an amount of from about 0.1 wt. % to about 5 wt. % of the solids of the electrophotographic ink composition, in some examples in an amount of from about 0.1 wt. % to about 2 wt. % of the solids of the electrophotographic ink composition, in some examples in an amount of from about 0.1 wt. % to about 2 wt. % of the solids of the electrostatic ink composition, in some examples in an amount of from about 0.3 wt. % to about 1.5 wt. % of the solids of the electrophotographic ink composition, in some examples from about 0.5 wt. % to about 1.2 wt. % of the solids of the electrophotographic ink composition, in some examples from about 0.8 wt. % to about 1 wt. % of the solids of the electrophotographic ink composition, in some examples from about 1 wt. % to about 3 wt. % of the solids of the electrophotographic ink composition, in some examples from about 1.5 wt. % to about 2.5 wt. % of the solids of the electrophotographic ink composition.

The resin, pigment, and synthetic charge director may be combined and milled/ground to form a paste. The charge director may be added before or during milling/grinding. A carrier liquid may be used to dilute the paste to form a slurry. An electrophotographic ink may be formed with the slurry.

In some examples, the grinding or milling process may be thermally controlled, e.g., to maintain a constant temperature during the grinding process. The temperature may be room temperature or, for example, about 25° C. In some example, the temperature may be maintained (i.e., kept constant) at any temperature or may decrease over a period of time within a temperature ranging from about 20 to about 80° C., for example, from about 25 to about 60° C. or, for example, from about 25 to about 55° C., or from about 25 to about 50° C., or from about 30 to about 45° C.

In some examples, the pigment, resin, and charge director, such as a synthetic charge director, may be mixed in a mixer (e.g., double planetary mixer and the like). In some example, the milling/grinding may be made with a time to form a paste. In some examples, the mixture may be ground/milled for a period of time from about 10 minutes to about 60 hours, for example, from about 30 minutes to about 59 hours, or from about 1 hour to about 58 hours, or from about 2 hours to about 57 hours, or from about 10 hours to about 54 hours, or from about 15 hours to about 50 hours, or in some example, at least about 35 hours, or at least about 40 hours, or at least about 43 hours, or at least about 45 hours.

In some examples, the mixture may be ground/milled for a period of time and the grinding speed may vary depending on the amount of material to be ground, the desired viscosity and/or the desired particle size of solid particles in ink composition, and the size and type of the grinding/milling apparatus.

In some example, the total non-volatile solids content during milling/grinding to form the mixture of pigment, resin, and charge director may be less than about 40% by weight, for example from about 15% to about 40% by weight, for example, less than about 30% by weight, for example, less than about 25% by weight, for example, less than about 20% by weight, for example, less than about 15% by weight, for example, less than about 10% by weight.

The liquid electrophotographic ink composition may be formed by vigorously agitating the mixture, e.g., by shearing. Agitation/shearing may be conducted by conventional devices such as ultrasonic dispersers, or high speed mechanical mixers such as Rotor/stator mixer, Ystral® or Ultra Turrax®. Agitation/shearing may be carried for a period of time of at least about 30 seconds, for example, at least about 1 minute.

The following examples illustrate examples of the disclosure that are presently best known. However, it is to be understood that the following are only examples or illustrative of the application of the principles of the present disclosure. Numerous modifications and alternative compositions, methods, and systems may be devised by those skilled in the art without departing from the spirit and scope of the present disclosure. The claims are intended to cover such modifications and arrangements. Thus, while the present disclosure has been described above with particularity, the following examples provide further details in connection with what are presently deemed to be the most practical and preferred examples of the disclosure.

### EXAMPLES

### Example 1

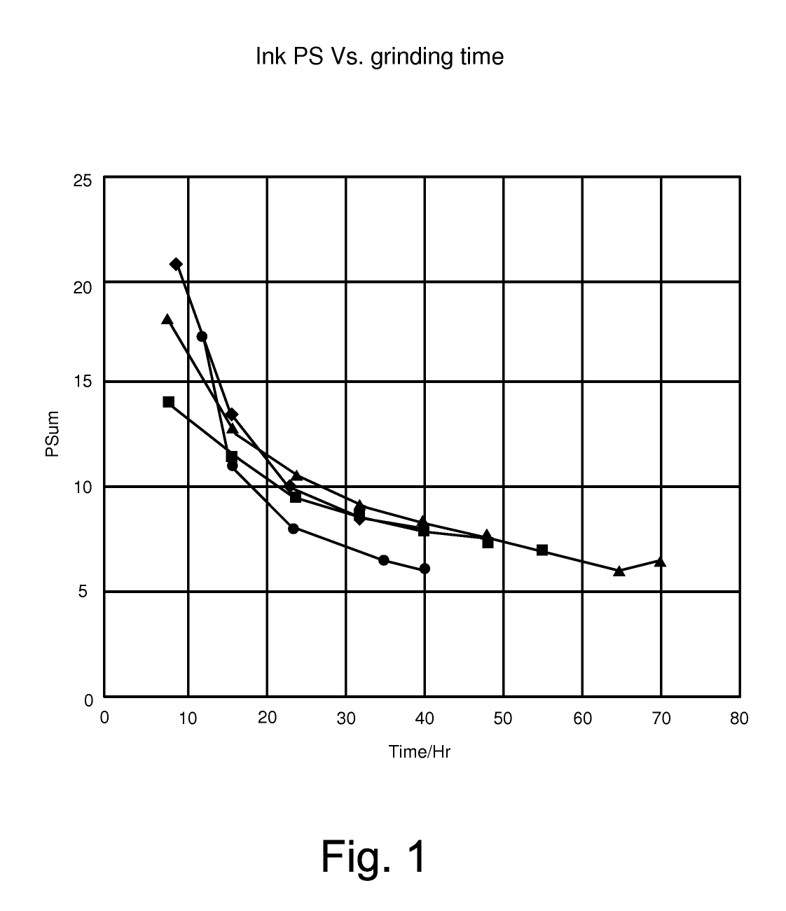

A mixture of resins (about 630 kg of NUCREL® 925, NUCREL® 2806, and BYNELL® 2022 available from DuPont) were mixed in a Ross double planetary mixer with a carrier liquid (1500 grams of ISOPAR L available from Exxon Mobil Corporation) at a speed of 60 rpm and a temperature of 130° C., for one hour. The temperature was reduced, mixing continued, until room temperature was reached. The mixture was charged into a S1 attritor (made by Union Process), with about 50 grams of pigment. The mixture was ground for 2 hours at 55° C., followed by grinding for 10 hours at 40° C., resulting in about 21% non-volatiles solids during grinding. The mixture was charged with a charge director and diluted with additional carrier liquid to produce a liquid electrophotographic ink having 2% NVS, with 98% of the carrier liquid being ISOPAR L (Ink A having triangle data points in FIGS. 1-3) was prepared.

### Example 2

A mixture of resins (about 630 kg of NUCREL® 925, NUCREL® 2806, and BYNELL® 2022 available from DuPont) were mixed in a Ross double planetary mixer with a carrier liquid (1500 grams of ISOPAR L available from Exxon Mobil Corporation) at a speed of 60 rpm and a temperature of 130° C., for one hour. The temperature was reduced, mixing continued, until room temperature was reached. The mixture was charged into a S1 attritor (made by Union Process), with about 50 grams of pigment and 2 mg/gr of a charge director. The mixture was ground for 2 hours at 55° C., followed by grinding for 10 hours at 40° C., resulting in about 23% non-volatiles solids during grinding. The mixture was diluted with additional carrier liquid to produce a liquid electrophotographic ink having 2% NVS, with 98% of the carrier liquid being ISOPAR L (Ink D having circle data points in FIGS. 1-3) was prepared.

### Example 3

The procedure described in Example 2 was used to produce another ink (Ink B having square data points in FIGS. 1-3). This ink had 21% non-volatile solids and was made with 1 mg/gr of a charge director.

### Example 4

The procedure described in Example 2 was used to produce another ink (Ink C having diamond data points in FIGS. 1-3). This ink had 23% non-volatile solids and was made with 1.33 mg/gr synthetic charge director.

### Example 5

The following inks were tested and compared. Example 1—Ink A having triangle data points; Example 3—Ink B having square data points; Example 4—Ink C having diamond data points; and Example 2—Ink D having circle data points.

FIG. 1 illustrates the particle size of the inks A-D as shown over a period of time for grinding. Ink A from Example 1 was prepared using a grinding process, but without the inclusion of a charge director. Inks B and C were prepared using a grinding process and included 1 mg/gr or 1.33 mg/gr charge director, respectively. Ink D from Example 2 was prepared using a grinding process and included 2 mg/gr of charge director. As compared to the other inks, Ink D exhibited a decreased particle size in a shorter period of time as compared to the other inks (A-C). Particle size was measured in a Malvern Mastersizer 2000 (available in Worcestershire, UK).

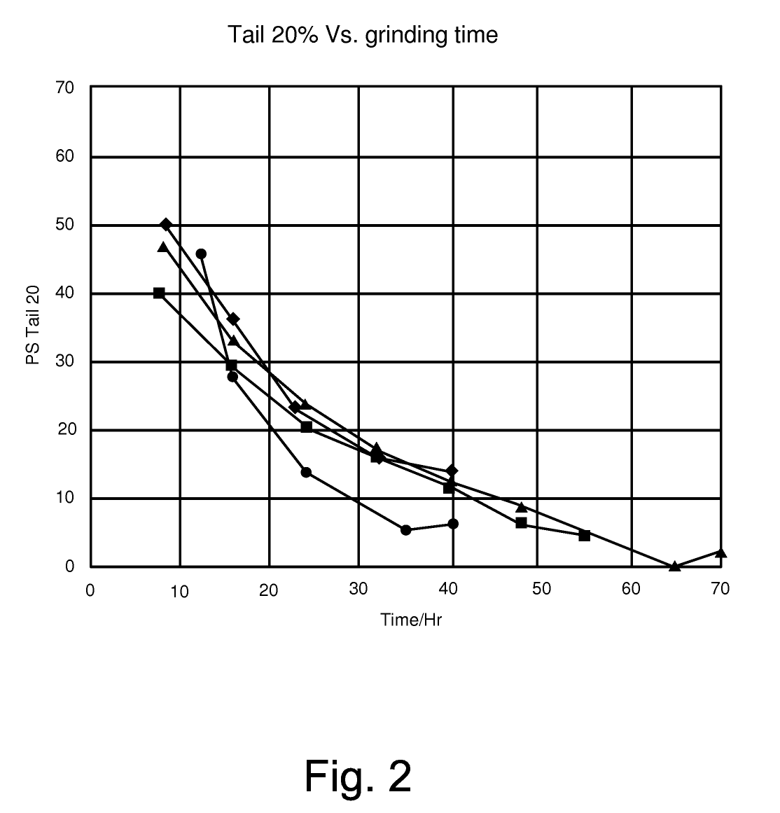

FIG. 2 illustrates that Ink D from Example 2 exhibited a better Tail 20% reduction as compared to the other inks (A-C).

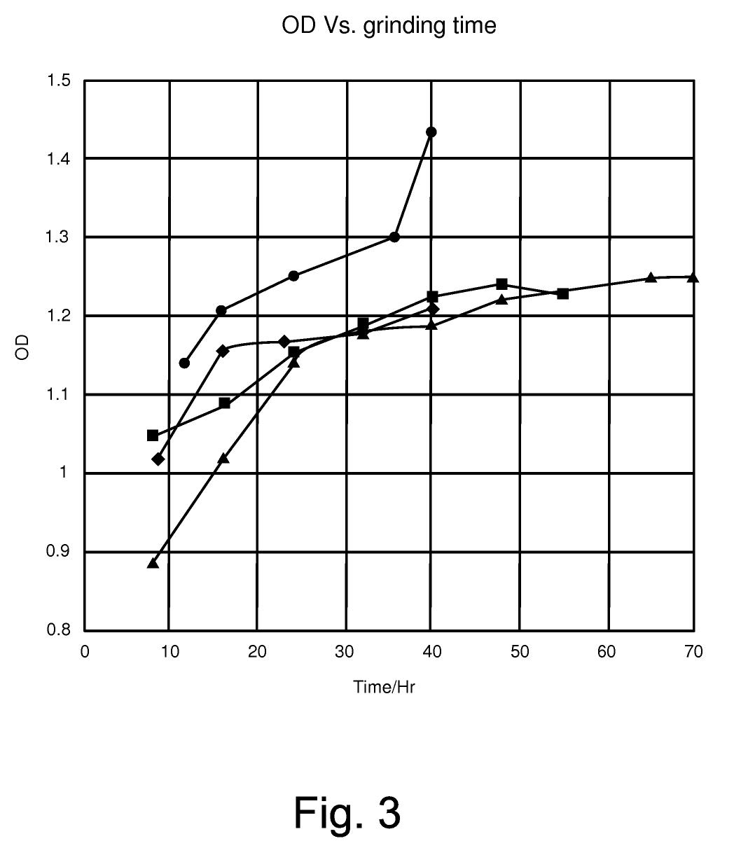

FIG. 3 illustrates the optical density of the inks A-D over the grinding time of the process. Ink D from Example 2 exhibited color development faster and higher as compared to the other inks (A-C). An optical density (OD) was determined using a 518 Spectrodensitometer available from X-Rite in Grand Rapids, Mich.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. A liquid electrophotographic ink comprising:
a resin;
a charge director; and
a pigment;
wherein the charge director is present in the liquid electrophotographic ink in an amount ranging from about 1.5 mg/gr to about 4.0 mg/gr of solids of the liquid electrophotographic ink.

2. The ink of claim 1, wherein the charge director is present in the liquid electrophotographic ink in an amount ranging from about 1.75 mg/gr to about 2.5 mg/gr of solids of the liquid electrophotographic ink.

3. The ink of claim 1, wherein the charge director is present in the liquid electrophotographic ink in an amount ranging from about 2.0 mg/gr of solids of the liquid electrophotographic ink.

4. The ink of claim 1, wherein the resin has an acid content of at least 15 wt. %.

5. The ink of claim 1, wherein the resin has a melt viscosity of at least 20,000 poise.

6. The ink of claim 1, wherein the resin is selected from the group consisting of ethylene acrylic acid copolymers; methacrylic acid copolymers; ethylene vinyl acetate copolymers; copolymers of ethylene and alkyl ester of methacrylic or acrylic acid; copolymers of ethylene acrylic or methacrylic acid and alkyl ester of methacrylic or acrylic acid; copolymers of acrylic or methacrylic acid and at least one alkyl ester of acrylic or methacrylic acid; ethylene-acrylate terpolymers: ethylene-acrylic esters-maleic anhydride or glycidyl methacrylate terpolymers; ethylene-acrylic acid ionomers; and
combinations thereof.

7. The ink of claim 1, wherein the pigment is selected from the group consisting of cyan pigments, magenta pigments, yellow pigments, white pigments, black pigments, phosphorescent pigments, electroluminescent pigments, photoluminescent pigments, pearlescent pigments, and combinations thereof.

8. The ink of claim 1, wherein the charge director is a sulfosuccinate salt of the general formula MAn, in which M is a metal, n is the valence of M, and A is a ion of the general formula (I):
[R¹—O—C(O)CH₂CH(SO₃⁻)C(O)—O—R²]⁻ (I)
in which each of R¹ and R² may be an alkyl group.

9. The ink of claim 1, wherein the total non-volatile solids of the ink is from about 15% to about 40% by weight.

10. The ink of claim 1, wherein the total non-volatile solids of the ink has less than about 25% by weight.

11. A method comprising:
grinding a resin, a charge director, and a pigment to form a paste;
diluting the paste to form a slurry; and
forming a liquid electrophotographic ink with the slurry.

12. The method of claim 11, wherein the charge director is present in the liquid electrophotographic ink in an amount ranging from about 1.5 mg/gr to about 4.0 mg/gr of solids of the liquid electrophotographic ink.

13. The method of claim 11, wherein the grinding lasts for a period of time from about 10 hours to about 54 hours.

14. The method of claim 11, wherein the grinding lasts for a period of time from about 15 hours to about 50 hours.

15. The method of claim 11, wherein the liquid electrophotographic ink exhibits an increased optical density in a shorter period of time as compared to a liquid electrophotographic ink that does not contain a charge director.
